(19) United States
(12) Patent Application Publication
(10) Pub. No.: US 2006/0046114 A1
(43) Pub. Date: Mar. 2, 2006

(54) Fuel cell system

(75) Inventors: Hiroaki Kato, Toyota-shi (JP); Kazumasa Takada, Nishikamo-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: AISIN SEIKI KABUSHIKI KAISHA, Kariya-shi (JP); TOYOTA JIDOSHA KABUSHIKI KAISHA, Toyota-shi (JP)

(21) Appl. No.: 11/199,090

(22) Filed: Aug. 9, 2005

(30) Foreign Application Priority Data
Aug. 27, 2004 (JP) 2004-249369

(51) Int. Cl. H01M 8/04; H01M 8/06

(52) U.S. Cl. 429/22; 429/20

(57) ABSTRACT

A fuel cell system includes a reforming portion for reforming a fuel into a reformed gas to be supplied into a fuel cell, a combustion portion for combusting an off-gas-contained fuel, an off-gas-contained hydrogen, and a fuel supplied directly from a fuel source with an oxidative gas supplied by an oxidative gas-supplying device for heating the reforming portion, a device for calculating the amount of the oxidative gas required for complete combustion of the off-gas-contained fuel, the off-gas-contained hydrogen, and the fuel supplied directly from the fuel source respectively, a summing device for summing the calculated respective amounts of the oxidative gas, and a device for controlling the amount of the oxidative gas supplied to the combustion portion according to the calculated required amount of the oxidative gas.

### CROSS REFERENCE TO RELATED APPLICATIONS

This application is based on and claims priority under 35 U.S.C. § 119 to Japanese Patent Application 2004-249369, filed on Aug. 27, 2004, the entire content of which is incorporated herein by reference.

### FIELD OF THE INVENTION

This invention generally relates to a fuel cell system.

### BACKGROUND

JPH6-333587A describes a conventional fuel cell system. As described in the document, an off-gas-contained fuel exhausted from a fuel electrode 2 of a fuel cell 1 is supplied to a burner (combustion portion) 8 of a fuel reformer 5. The off-gas-contained fuel is combusted by air supplied to the burner 8 of controlled flow rate through an air supply system 17 by operations of a blower 18.

In this case, the amount of the air required for combusting the off-gas-contained fuel at the burner 8 is calculated on the basis of a flow rate of original fuel detected by an original fuel flowmeter 12 and a load current detected by an ampere meter 25 as follows. Subtracting the amount of air containing oxygen consumed for cell reaction corresponding to the load current detected by the ampere meter 25 from the amount of air containing oxygen required for combusting the amount of the original fuel of the flow rate detected by the original fuel flowmeter 12 considering a delay time T by a control apparatus 30 from when the flow rate was detected by the original fuel flowmeter 12 to when the fuel reaches the fuel cell 1 through the fuel reformer 5 yields the amount of air containing the amount of oxygen required for combusting an off-gas-contained fuel. Accordingly, a product of the amount of air for combusting the off-gas-contained fuel and an air-fuel ratio is transmitted to an air-supply controller 32 as a target value. Then, a rotational frequency of the blower 18 is controlled so that the air of the target amount required for combustion can be supplied.

JPH7-89493B2 describes another conventional fuel cell system. As described in a former embodiment of the document, a fuel gas as a reducer delivered from a reformer reaction pipe 16 is delivered into a fuel cell (FC) 18 through a shift converter (not illustrated) and a flow control valve 17. Then, an off-gas-contained fuel exhausted from the FC 18 is supplied to a reformer main burner 20 (a combustion portion is configured from the reformer main burner 20 and a reformer sub burner 23) through a pipe 19. On the other hand, a part of the original fuel supplied to a fuel-inlet 11 is supplied to the reformer sub burner 23 through a pipe 21 and a flow control valve 22. In this case, a sub burner output calculator 33 feeds flow rate signals F1, F2, F3 obtained by flowmeters 24, 25, 26 and temperature signals T1, T2 obtained by temperature gauges 28, 29, calculates flow rate control signals M, in other words, the amount of the fuel supplied to the reformer sub burner 23 (the amount of the fuel supplied for combustion) considering excess and deficiency of heat exchange at the reformer (reforming portion) 15, and output the calculation result to a controller 32. Accordingly, the amount of the fuel required for maintaining the steady temperature of the reformer reaction pipe 16 is supplied. In addition, a reforming rate calculator 37 of the sub burner output calculator 33 assumes the reforming ratio on the basis of the temperature of the reformer reaction pipe 16, in other words, temperature signals T1 obtained by the temperature gauge 28.

In addition, as described in the latter embodiment of the document, a fuel gas exhausted from a fuel electrode of a fuel cell 104 is supplied to a reformer main burner 107 (a combustion portion is configured from the reformer main burner 107 and a reformer sub burner 108) in a combustion chamber of a reformer (reforming portion) 101. Methane as a fuel gas is supplied to the reform sub burner 108 from outside. In this case, a first calculation apparatus 112 feeds detection signals FA, FB, FC, FD transmitted from a flowmeter 110A, 110B, 110C, 110D and I transmitted from an ampere meter 111, and calculates the amount of energy Q of combustion in the combustion chamber of the reformer 101 on the basis of fed signals and scientific knowledge in regard to a reform reaction, a combustion reaction or the like considering composition changes of the fuel gas. A second calculation apparatus 113 compares the amount of energy of combustion depending on the detection signal I transmitted from the ampere meter 111 and the amount of energy Q of combustion calculated by the first calculation apparatus 112, and transmits a control signal Vc for controlling level of opening a flow control valve 109 on the basis of the results of comparison. Accordingly, a flow rate of methane as the fuel gas supplied to the flow control valve 109 can be controlled.

JP2003-183005A describes a still another conventional fuel cell system. According to the document, a reform conversion rate of hydrocarbon series fuel in a reforming apparatus is made less than 90%. Thus, the all or almost all amount of heat for the reforming portion can be obtained from combustion heat of an off-gas from a fuel cell. In other words, a fuel gas is not supplied to the combustion portion, and only the off-gas of the fuel cell is supplied to the combustion portion.

In addition, according to the former part of JPH7-89493B2, in the fuel cell system, the amount of the fuel supplied to the reformer sub burner 23 (the amount of the fuel supplied for combustion) is calculated on the basis of the flow rate signals F1, F2, F3 obtained by the flowmeters 24, 25, 26 and the temperature signals T1, T2 obtained by the temperature gauges 28, 29 considering excess and deficiency of heat exchange of the reformer (reforming portion) 15. In other words, only the flow rate of fuel supplied for combustion is calculated. Calculations about combustion air (the amount of the oxidative gas required for combustion) are not mentioned. Further, according to the latter part of JPH7-89493B2, in the fuel cell system, a flow rate of methane (fuel supplied for combustion) as the fuel gas supplied to the flow control valve 109 is determined considering the off-gas-contained fuel, and controlled according to the determined result. In the document also, only flow rate of the fuel supplied for combustion is calculated, and calculations about combustion air (the amount of oxidative gas required for combustion) is not mentioned. Further, according to JP2003-183005A, calculations for combustion air (the amount of the oxidative gas required for combustion) in the fuel cell system is not mentioned.

According to JPH6-333587A2, as can be clearly grasped from equations 2 and 3 described in the document, it is presumed that substantial part of the original fuel is converted into hydrogen in the reforming portion. In other words, the presence of the fuel not having been converted into hydrogen (off-gas-contained fuel) in the reforming portion is not considered. Accordingly, there is a danger that oxidative gas of appropriate amount cannot be supplied to the burner 8.

A need thus exists for a fuel cell system in which a sufficient amount of an oxidative gas for combusting a burnable gas supplied to a combustion portion is determined considering an off-gas-contained fuel, and the oxidative gas is supplied to the combustion portion according to the determined result. The present invention has been made in view of the above circumstances and provides such a fuel cell system.

### SUMMARY OF THE INVENTION

A fuel cell system includes a reforming portion including a reforming catalyst filled inside the reforming portion for reforming a fuel supplied to the reforming portion into a reformed gas to be introduced to a fuel cell containing hydrogen, a combustion portion for complete combustion of an off-gas-contained fuel supplied from the fuel cell, an off-gas-contained hydrogen also supplied from the fuel cell, and the fuel supplied directly from a fuel source as a required basis with an oxidative gas supplied by an oxidative gas-supplying means for supplying the oxidative gas to the combustion portion for heating the reforming portion, a means for calculating the amount of the oxidative gas required for complete combustion of the off-gas-contained fuel supplied to the combustion portion, a means for calculating the amount of the oxidative gas required for complete combustion of the off-gas-contained hydrogen supplied to the combustion portion, a means for calculating the amount of the oxidative gas required for complete combustion of the fuel supplied directly from the fuel source to the combustion portion on the basis of the amount of the fuel supplied directly from the fuel source to the combustion portion, a summing means for calculating the total amount of the required oxidative gas by summing the amount of the required oxidative gas calculated by each means for calculating described above, and a means for controlling the oxidative gas-supplying means for supplying the oxidative gas to the combustion portion according to the amount of the required oxidative gas calculated by the summing means.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a schematic view illustrating a fuel cell system according to an embodiment of the present invention;

FIG. 2 represents a block diagram illustrating the fuel cell system illustrated in FIG. 1;

FIG. 3 represents a block diagram illustrating a control apparatus illustrated in FIG. 2;

FIG. 4 represents a block diagram illustrating a portion for calculating a conversion rate illustrated in FIG. 3;

FIG. 5 represents a block diagram illustrating a portion for calculating the amount of an off-gas-contained hydrogen illustrated in FIG. 3;

FIG. 6 represents a graph illustrating relations between a flow rate of an actual off-gas-contained fuel (off-gas-contained methane) and an assumed amount of the off-gas-contained fuel; and

FIG. 7 represents a graph illustrating relations between a flow rate of an actual off-gas-contained hydrogen and an assumed amount of the off-gas-contained hydrogen.

### DETAILED DESCRIPTION

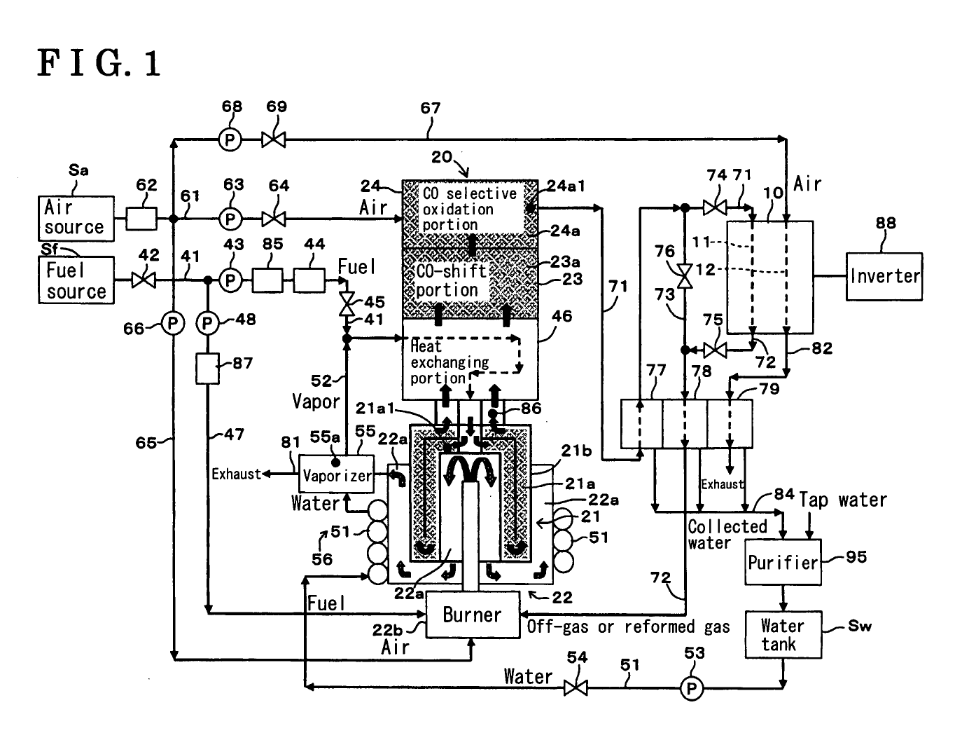

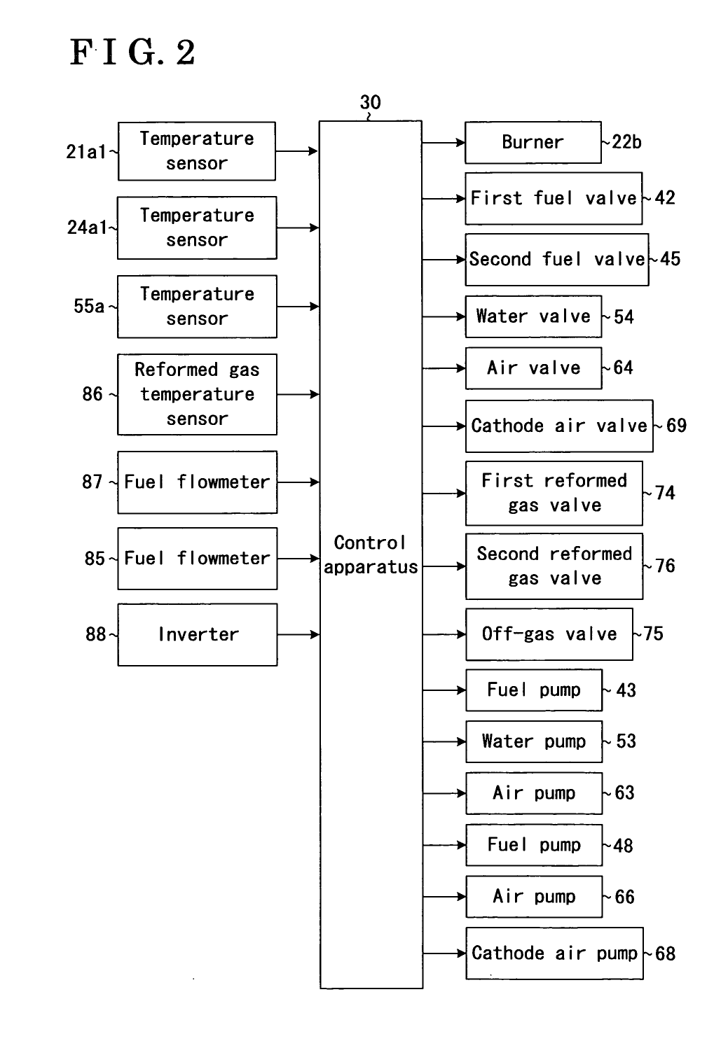

An embodiment of the present invention will be explained with reference to drawing figures. FIG. 1 represents a schematic diagram illustrating an overview of a fuel cell system. As illustrated in FIG. 1, the fuel cell system includes a fuel cell 10 and a reforming apparatus 20 of a vapor-reforming type for generating hydrogen gas required for the fuel cell 10. The fuel cell 10 includes a fuel electrode 11 and an air electrode 12. The fuel cell 10 generates electricity utilizing a reformed gas supplied to the fuel electrode 11 and air (cathode air) supplied to the air electrode 12. An inverter 88 is connected to the fuel cell 10. The inverter 88 converts direct current flowing from the fuel cell 10 into alternating current. The alternating current flows into an electric load (electric appliance or the like). The inverter 88 further has a function for measuring direct current flowing from the fuel cell 10, and for transmitting measured signals to a control apparatus 30 (illustrated in FIG. 2). In other words, the inverter 88 serves as an output current-detecting means for detecting output current flowing from the fuel cell 10.

The reforming apparatus 20 includes a reforming portion 21 for reforming a fuel, a carbon monoxide-shift reaction portion (referred to a CO-shift portion later) 23 for removing carbon monoxide contained in the reformed gas introduced from the reforming portion 21, and a carbon monoxide selective oxidation portion (referred to a CO selective oxidation portion later) 24 for further removing carbon monoxide contained in the reformed gas introduced from the CO-shift portion 23. For fuel, natural gas, liquefied petroleum gas (LPG), coal oil, gasoline, methanol, or the like, can be employed. In the embodiment, natural gas is employed.

The reforming portion 21 is formed to be a cylinder having a bottom and provided so as to open downward. The reforming portion 21 includes a reaction chamber 21b in which a reforming catalyst 21a is filled. In the reforming portion 21, a combustion portion 22 is provided. The combustion portion 22 includes a heat chamber 22a provided close to the reaction chamber 21b for heating the reaction chamber 21b and a burner 22b for supplying combustion gas of high temperature to the heat chamber 22a.

A fuel supply-pipe 41 connected to a fuel source Sf (town gas pipe or the like) is connected to the reaction chamber 21b. A fuel is supplied from the fuel source Sf. A first fuel valve 42, a fuel pump 43, a flowmeter 85 for measuring the fuel supplied to the reaction chamber 21b, a desulfurizer 44, a second fuel valve 45, and a heat-exchanging portion 46 are provided at the fuel supply-pipe 41 in series from upstream. The first fuel valve 42 and the second fuel valve 45 open/close the fuel supply-pipe 41 on the basis of commands from the control apparatus 30. The fuel pump 43 pumps the fuel from the fuel source Sf into the reaction chamber 21b of the reforming portion 21. The fuel pump 43 controls the amount of the fuel supplied to the reaction chamber 21b on the basis of commands from the control apparatus 30. The flowmeter 85 detects the amount of the fuel supplied to the reforming portion 21. Detection signals are transmitted to the control apparatus 30. The desulfurizer 44 removes sulfur (sulfur compound or the like) contained in the fuel. In the heat-exchanging portion 46, the fuel is heated in advance by changing heat with the fuel of high temperature flowing from the reforming portion 21 to the CO-shift portion 23, and supplied to the reaction chamber 21b of the reforming portion 21. Accordingly, sulfur is removed from the fuel, the fuel is heated in advance, and the fuel is supplied to the reaction chamber 21b.

A vapor supply-pipe 52 connected to a vaporizer 55 is connected to the fuel supply-pipe 41 between the second fuel valve 45 and the heat-exchanging portion 46. Vapor supplied from the vaporizer 55 is mixed into the fuel. The fuel is supplied to the reaction chamber 21b of the reforming portion 21. A water supply-pipe 51 connected to a water tank Sw serving as a water source is connected to the vaporizer 55. A water pump 53 and a water valve 54 are provided at the water supply-pipe 51 in series from upstream. The water pump 53 pumps water from the water tank Sw into the vaporizer 55. The amount of the water supplied to the vaporizer 55 is controlled on the basis of commands from the control apparatus 30. The water valve 54 opens/closes the water-supply pipe 51 on the basis of commands from the control apparatus 30. The water supply-pipe 51 is wound around the heat chamber 22a so that the water flowing in the water supply-pipe 51 is heated by the heat chamber 22a of high temperature in advance. An exhaust pipe 81, one end thereof connected to the heat chamber 22a and the other end opened to outside, penetrates the vaporizer 55. The vaporizer 55 heats the supplied water heated in advance by the combustion gas (exhaust gas) flowing in the exhaust pipe 81 exhausted from the heat chamber 22a to outside. The heated water becomes vapor, and the vapor is supplied to the reaction chamber 21b. Accordingly, the water is heated in advance and supplied to the vaporizer 55. The water is changed into vapor and the vapor is supplied to the reaction chamber 21b. In addition, in the embodiment, the vaporizer 55 and a portion of the water supply-pipe 51 wound around the heat chamber 22a configure a vaporizing portion 56. Further, a temperature sensor 55a for detecting inner temperature of the vaporizer 55 is provided in the vaporizer 55.

The reaction chamber 21b is heated by the combustion gas of the burner 22b, as is mentioned later. As indicated by chemical equation 1, the fuel reacts with the vapor, both supplied into the reaction chamber 21b, through the reforming catalyst 21a (Ru, Ni series catalyst). Then, hydrogen gas and carbon monoxide is generated through the reform of the fuel with the vapor (so called reform reaction with vapor). At the same time, in the reaction chamber 21b, as indicated by chemical equation 2, carbon monoxide shift reaction is performed in which the carbon monoxide generated in the process of reform reaction with vapor reacts with vapor and formed into hydrogen gas and carbon dioxide. These gases (so called a reformed gas) is cooled while flowing in the heat-exchanging portion 46 and introduced into the CO-shift portion 23. In addition, the reformed gas further contains unconverted methane, which has not converted into hydrogen in the reforming portion 21.
CH₄+H₂O→3H₂+CO−Q1 [Chemical Equation 1]
CO+H₂O→H₂+CO₂+Q2 [Chemical Equation 2]
The reform reaction with vapor is an endothermic reaction. As can be clearly seen from chemical equation 1, a heat Q1 is absorbed when the reaction proceeds rightward. Inversely, the heat Q1 is generated when the reaction proceeds leftward. In addition, the carbon monoxide shift reaction is an exothermic reaction. As can be clearly seen from chemical equation 2, a heat Q2 is generated when the reaction proceeds rightward. Inversely, the heat Q2 is absorbed when the reaction proceeds leftward.

In addition, a temperature sensor 21a1 is provided in the reaction chamber 21b for detecting temperature of the reforming catalyst 21a. Further, a temperature sensor 86 serving as a reformed gas temperature-detecting means is provided at a pipe between a gas outlet of the reforming portion 21 (reaction chamber 21b) and the heat-exchanging portion 46 for detecting temperature of the gas extracted from the reforming portion 21. Signals emitted from the temperature sensors 21a1 and 86 are transmitted to the control apparatus 30.

In the CO-shift portion 23, as indicated by chemical equation 2, carbon monoxide contained in the supplied reformed gas reacts with vapor through a catalyst 23a (Cu—Zn series catalyst or the like) filled in the CO-shift portion 23, and is changed into hydrogen gas and carbon dioxide gas, so called a carbon monoxide shift reaction. Accordingly, concentration of the carbon monoxide contained in the extracted reformed gas is lowered.

The reformed gas extracted from the CO-shift portion 23, of which the concentration of carbon monoxide is lowered, is supplied into the CO selective oxidation portion 24. Further, an air supply-pipe 61 connected to an air-source Sa is connected to the CO selective oxidation portion 24. Air is supplied from the air source (atmospheric air or the like) Sa to the CO selective oxidation portion 24. A filter 62, an air pump 63, and an air valve 64 are provided at the air supply-pipe 61 in series from upstream. The filter 62 filtrates air. The air pump 63 pumps air from the air source Sa into the CO selective oxidation portion 24. The air pump 63 controls the amount of air supplied on the basis of commands from the control apparatus 30. The air valve 64 opens/closes the air supply-pipe 61 on the basis of commands from the control apparatus 30. Accordingly, air is supplied to the CO selective shift portion 24.

As indicated by chemical equation 3, carbon monoxide remained in the reformed gas supplied into the CO selective oxidation portion 24 reacts with air supplied as described above through a catalyst 24a (Ru series, Pt series or the like) filled in the CO selective oxidation portion 24 into carbon dioxide. Accordingly, the concentration of carbon monoxide contained in the reformed gas is further lowered through oxidative reaction (down to 10 ppm or less). Then, the reformed gas is extracted and supplied to the fuel electrode 11 of the fuel cell 10. In addition, a part of hydrogen contained in the reformed gas is also oxidized into water. In addition, a temperature sensor 24a1 is provided in the CO selective oxidation portion 24 for detecting temperature of the catalyst 24a.

$$CO + \frac{1}{2} {O}_{2} -> {CO}_{2} + Q3 \qquad [ Chemical Equation 3 ]$$

The reaction is an exothermic reaction. As is clearly seen from chemical equation 3, a heat Q3 is generated when the reaction proceeds rightward. Inversely, the heat Q3 is absorbed when the reaction proceeds leftward.

The CO selective oxidation portion 24 is connected to an inlet of the fuel electrode 11 of the fuel cell 10 through a reformed gas supply-pipe 71. Thus, the reformed gas is supplied to the fuel electrode 11. An outlet of the fuel electrode 11 of the fuel cell 10 is connected to the burner 22b through an off-gas supply-pipe 72. Thus, an off-gas from an anode (the reformed gas containing hydrogen not having been reacted at the fuel electrode) exhausted from the fuel cell 10 is supplied to the burner 22b. A bypass pipe 73 directly connects the reformed gas supply-pipe 71 and the off-gas supply-pipe 72 bypassing the fuel cell 10. A first reformed gas valve 74 is provided at the reformed gas supply-pipe 71 between a branch point to the bypass pipe 73 and the fuel cell 10. An off-gas valve 75 is provided at the off-gas supply-pipe 72 between a merging point with the bypass pipe 73 and the fuel cell 10. A second reformed gas valve 76 is provided at the bypass pipe 73. The first reformed gas valve 74, the second reformed gas valve 76, and the off-gas valve 75 open/close respective pipes. The first reformed gas valve 74, the second reformed gas valve 76, and the off-gas valve 75 are controlled by the control apparatus 30.

Further, one end of an air supply-pipe 67 branched from the air supply-pipe 61 at the upstream of the air pump 63 is connected to an inlet of the air electrode 12 (cathode) of the fuel cell 10. Thus, air is supplied to the air electrode 12. An air pump 68 and an air valve 69 are provided at the air supply-pipe 67 in series from upstream. The air pump 68 pumps air from the air source Sa into the air electrode 12 of the fuel cell 10. The air pump 68 is controlled on the basis of commands from the control apparatus 30 to control the amount of air supplied to the air electrode 12. The air valve 69 opens/closes the air supply-pipe 67 on the basis of commands from the control apparatus 30. Further, one end of an exhaust pipe 82, of which the other end is opened to outside, is connected to an outlet of the air electrode 12 of the fuel cell 10.

Further, a fuel supply-pipe 47 branched from the fuel supply-pipe 41 at the upstream of the fuel pump 43 is connected to the burner 22b for directly supplying fuel to the combustion portion 22 from the fuel source Sf (without passing through the fuel cell 10). A fuel pump 48 and a flowmeter 87 for measuring a flow rate of the fuel directly supplied to the combustion portion 22 are provided at the fuel supply-pipe 47 in series from upstream. The fuel pump 48 pumps the fuel from the fuel source Sf toward the burner 22b. The fuel pump 48 is controlled on the basis of commands from the control apparatus 30 to control the amount of fuel supplied to the burner 22b. The flowmeter 87 detects the amount of the fuel supplied to the combustion portion 22. The detected signals are transmitted to the control apparatus 30.

Further, an air supply-pipe 65 branched from the air supply-pipe 61 at the upstream of the air pump 63 is connected to the burner 22b for supplying air serving as an oxidative gas for combusting the fuel, the reformed gas, or off-gas from the anode. An air pump 66 is provided at the air supply-pipe 65. The air pump 66 pumps air from the air source Sa toward the burner 22b. The air pump 66 is controlled on the basis of commands from the control apparatus 30 for controlling the amount of air supplied to the burner 22b. When the burner 22b is ignited on the basis of commands from the control apparatus 30, the fuel, the reformed gas, or the off-gas from the anode, each supplied to the burner 22b, is combusted. Then, the combustion gas of high temperature is generated. The combustion gas is supplied to the heat chamber 22a, and thus the reaction chamber 21b is heated. Then, the reforming catalyst 21a is heated. The combustion gas having passed the heat chamber 22a is exhausted to outside as an exhaust gas through the exhaust pipe 81 and the vaporizer 55.

Further, a condenser 77 is provided in the middle of the reformed gas supply-pipe 71. A condenser 78 is provided in the middle of the off-gas supply-pipe 72. A condenser 79 is provided in the middle of the exhaust pipe 82. The condenser 77 condenses vapor contained in the reformed gas flowing in the reformed gas supply-pipe 71 to be supplied to the fuel electrode 11 of the fuel cell 10. The condenser 78 condenses vapor contained in the off-gas from the anode flowing in the off-gas supply-pipe 72 exhausted from the fuel electrode 11 of the fuel cell 10. The condenser 79 condenses vapor contained in the off-gas from the cathode flowing in the exhaust pipe 82 exhausted from the air electrode 12 of the fuel cell 10. In addition, each condenser includes a cooling medium pipe. A low temperature liquid stored in a tank or a liquid cooled by a radiator and a cooling fan is supplied to the cooling medium pipe. The vapor contained in each gas is condensed through heat exchange with the liquid.

The condensers 77, 78, 79 are connected to a purifier 95 through a pipe 84. Water condensed in the condensers 77, 78, 79 is introduced to the purifier 95 and collected. The purifier 95 purifies the condensed water, in other words, collected water, supplied from the condensers 77, 78, and 79 by means of ion-exchange resin installed in the purifier 95. Further, the purifier 95 discharges the purified collected water toward the water tank Sw. In addition, a pipe for charging supplement water (tap water) supplied from a tap water-source (tap water pipe or the like) is connected to the purifier 95. When the amount of water stored in the purifier 95 becomes less than lower limitation, tap water is supplied to the purifier 95.

Further, the fuel cell system includes the control apparatus 30. The temperature sensors 21a1, 24a1, 55a, 86, the flowmeters 85, 87, the inverter 88, the pumps 43, 48, 53, 63, 66, 68, the valves 42, 45, 54, 64, 69, 74, 75, 76, and the burner 22b are connected to the control apparatus 30 (Please refer to FIG. 2). The control apparatus 30 includes a microcomputer (not illustrated). The microcomputer includes an input/output interface, a central processing unit (CPU), a random access memory (RAM), and a read only memory (ROM), each of them connected by busses with others. The CPU feeds signals of temperatures transmitted from the temperature sensors 21a1, 24a1, 55a, and 86, signals of the amount of supply transmitted from the flowmeters 85 and 87, and a signal of output current transmitted from the inverter 88. On the basis of signals described above, the CPU controls the pumps 43, 48, 53, 63, 66, and 68, the valves 42, 45, 54, 64, 69, 74, 75, and 76, and the burner 22b. Thus, for obtaining preferable current output (current, power consumed by the load apparatus), the amount of the fuel supplied to the reforming portion 21, the amount of the fuel supplied to the combustion portion 22, the amount of the air supplied to the combustion portion 22, and the amount of the water supplied to the reforming portion 21 are controlled. The RAM temporary stores variables required for performing a program of controls described above. The ROM stores the program.

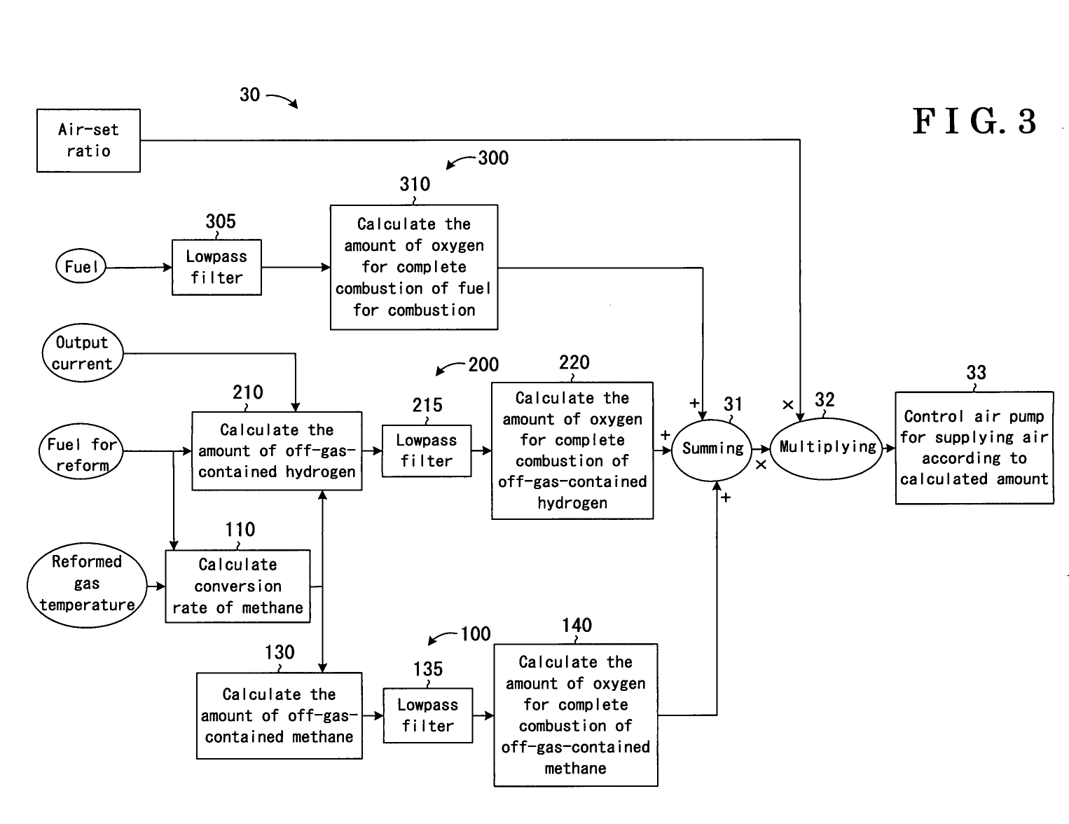

As illustrated in FIG. 3, the control apparatus 30 includes a portion 100 for calculating the amount of the oxidative gas required for complete combustion of the off-gas-contained fuel supplied to the combustion portion 22, a portion 200 for calculating the amount of the oxidative gas required for complete combustion of the off-gas-contained hydrogen supplied to the combustion portion 22, a portion 300 for calculating the amount of the oxidative gas required for complete combustion of the fuel directly supplied from the fuel source Sf to the combustion portion 22 on the basis of the amount of the fuel directly supplied from the fuel source Sf to the combustion portion 22, a summing portion 31 summing the amount of the required oxidative gas each calculated by the portions 100, 200, and 300 for calculating a total amount of the required oxidative gas, a multiplying portion 32 for multiplying the total amount of the oxidative gas calculated by the summing portion 31 and an air-set ratio for calculating the required amount of air considering properties of the reforming apparatus, and a portion 33 for controlling the air pump 66 serving as a means for controlling the oxidative gas-supplying means on the basis of the amount of the oxidative gas calculated by the multiplying portion 32. Here, a term “the amount required for complete combustion” includes a value theoretically derived. In addition, the air-set ratio is defined as a ratio of the amount of air suitable for properties of the reforming apparatus 20 to the amount of air required for complete combustion of 1 mole of a burnable gas such as fuel, the off-gas-contained hydrogen, and the off-gas-contained fuel. The air-set ratio is set to 1.2 or the like.

The portion 100 calculates the amount of the oxidative gas required for complete combustion of the off-gas-contained fuel supplied to the combustion portion 22 on the basis of the amount of the fuel supplied to the combustion portion 22 detected by the flowmeter 85 and the temperature of the reformed gas detected by the temperature sensor 86 serving as a reformed gas temperature-detecting means. The portion 100 includes a portion 110 for calculating a ratio of the fuel converted into hydrogen, in other words, a conversion rate, on the basis of the amount of the fuel supplied to the reforming portion 21 and the temperature of the reformed gas, a portion 130 for calculating the amount of the off-gas-contained fuel supplied to the combustion portion 22 on the basis of the amount of the fuel supplied to the reforming portion 21 and the conversion rate calculated by the portion 110, a portion 140 for calculating the amount of the oxidative gas required for complete combustion of the off-gas-contained fuel supplied to the combustion portion 22.

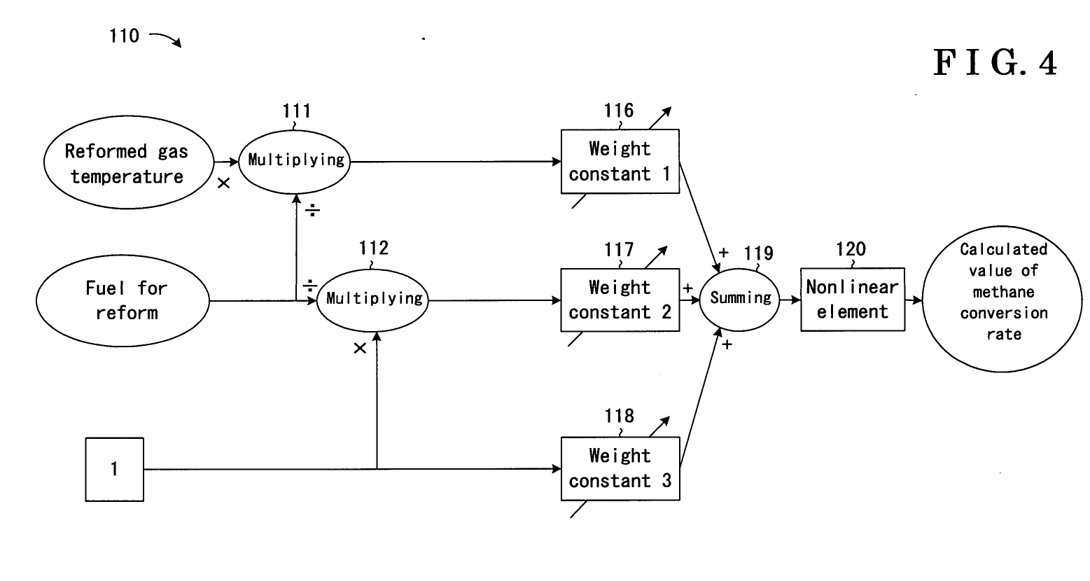

As illustrated in FIG. 4, the portion 110 is configured from a neural network. Specifically, the portion 110 learns weight constants 1 to 3 through a single layer of the neural network configured on the basis of properties that the conversion rate is proportional to the temperature of inside the reforming portion 21, in other words, the temperature of the reformed gas detected by the temperature sensor 86, and that the conversion rate is in inverse proportion to the amount of the fuel supplied to the reforming portion 21. In other words, in the portion 110, the temperature of the reformed gas is multiplied by an inverse of the amount of the fuel supplied to the reforming portion 21 in a multiplying portion 111, and the inverse of the amount of the fuel supplied to the reforming portion 21 is multiplied by a constant C1 (1 or the like) for offset in a multiplying portion 112. Values calculated by the portions 111 and 112, and a constant C1 are transmitted to weighting portions 116 to 118 respectively. The weighting portions 116 to 118 weight the transmitted values utilizing weight constants 1 to 3 respectively. Next, a summing portion 119 sums the weighted values transmitted from the weighting portions 116 to 118 together. Then, a nonlinear process portion 120 performs a nonlinear process on the summed value transmitted from the summing portion 119. Thus, the conversion rate is calculated. In addition, hyperbolic tangent (tanh) is employed for a nonlinear element. Accordingly, the conversion rate is calculated on the basis of the temperature of the reformed gas and the amount of the fuel supplied to the reforming portion 21 by equation 1.

$$Conversion rate = F ( \frac{Conv\_A \times Reformed gas Temp . [ °C ] + Conv\_B}{Fuel supplied for reform [ L \text{/} min ]} + Conv\_C ) \qquad [ Equation 1 ]$$

Here, Conv_A, Conv_B, Conv_C correspond to the weight constants 1 to 3 described above. In addition, the weight constants 1 to 3 have been learned in advance. F indicates a predetermined function including hyperbolic tangent (tanh).

The portion 130 calculates (assumes) the amount of the off-gas-contained fuel supplied to the combustion portion 22 by equation 2 on the basis of the amount of the fuel supplied to the reforming portion 21 and the conversion rate calculated by the portion 110. Because the off-gas-contained fuel corresponds to the fuel (natural gas) contained in the reformed gas not having been converted into hydrogen in the reforming portion 21, the amount of the off-gas-contained fuel supplied to the combustion portion 22 can be calculated by equation 2.
Supplied off-gas-contained fuel=Fuel supplied for reform [L/min]×Carbon value in fuel for reform×(1−Conversion rate [%]/100) [Equation 2]
In addition, the carbon value in fuel for reform corresponds to the average number of carbon atoms included in one molecule of the fuel supplied to the reforming portion 21.

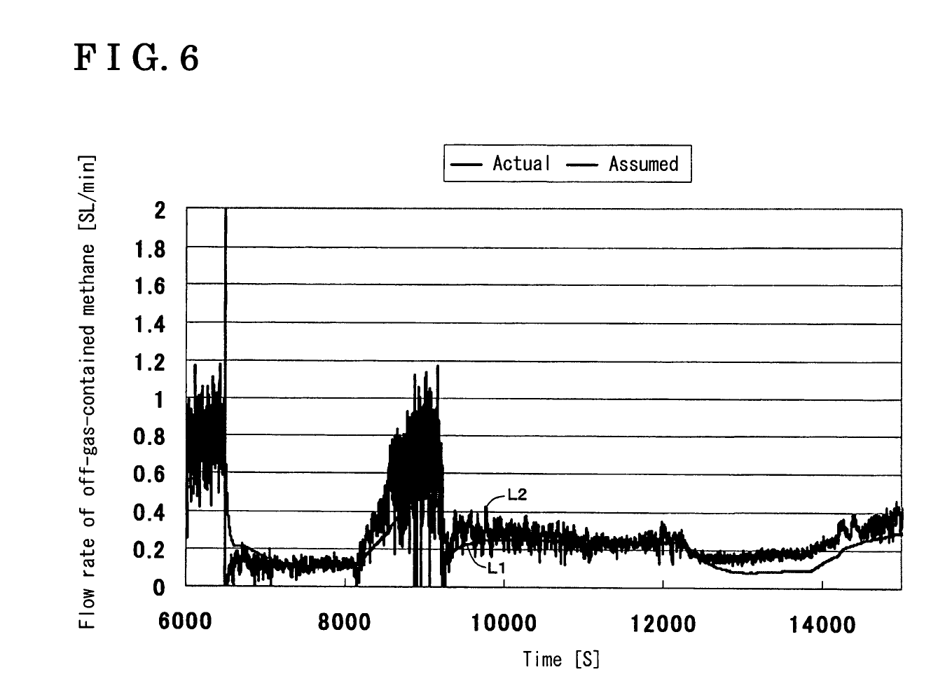

FIG. 6 represents a graph showing the amount of the off-gas-contained fuel (in terms of unit of standard litter per minute) supplied to the combustion portion 22 calculated as described above. The assumed amount of the off-gas-contained fuel supplied to the combustion portion 22 is drawn by a curve L1 drawn lighter. In the same graph, the actual amount of the off-gas-contained fuel supplied to the combustion portion 22 measured actually by means of a measuring apparatus is drawn by a curve L2 drawn darker. As can be clearly seen from FIG. 6, there is good correlation between the assumed amount of the off-gas-contained fuel supplied to the combustion portion 22 and the actual amount of the off-gas-contained fuel supplied to the combustion portion 22. Accordingly, the amount of the oxidative gas required for complete combustion of the off-gas-contained fuel supplied to the combustion portion 22 can be calculated in high precision.

The portion 140 calculates the amount of the oxidative gas required for complete combustion of the off-gas-contained fuel supplied to the combustion portion 22 by equation 3 on the basis of the amount of the off-gas-contained fuel supplied to the combustion portion 22 calculated by the portion 130.
Oxidative gas required for combustion of off-gas-contained fuel=9.254×Supplied off-gas-contained fuel [L/min] [Equation 3]
In addition, equation 3 is derived as follows.

Combustion reaction of methane is described by chemical equation 4. For complete combustion of 1 mole of methane, 2 moles of oxygen are required. Assuming that oxygen is contained in air by a ratio of 21%, the amount of air required for complete combustion of 1 mole of methane is described by equation 4.
CH₄+2O₂→2H₂O+CO₂ [Chemical Equation 4]
Required air=1/0.21×2 [mol]=9.524 [mol] [Equation 4]
In addition, the amount of air calculated above is a value calculated for the case that the air-set ratio is 1.

The portion 200 calculates the amount of the oxidative gas required for complete combustion of the off-gas-contained hydrogen supplied to the combustion portion 22 on the basis of the amount of the fuel supplied to the reforming portion 21, the output current of the fuel cell detected by the inverter 88 serving as an output current-detecting means, and the temperature of the reformed gas detected by the temperature sensor 86. The portion 200 includes the portion 110 for calculating a conversion rate described above, a portion 210 for calculating the amount of the off-gas-contained hydrogen supplied to the combustion portion 22 on the basis of the output current of the fuel cell 10, the amount of the fuel supplied to the reforming portion 21, and the conversion rate calculated by the portion 110, and a portion 220 for calculating the amount of the oxidative gas required for complete combustion of the off-gas-contained hydrogen supplied to the combustion portion 22 on the basis of the amount of the off-gas-contained hydrogen supplied to the combustion portion 22 calculated by the portion 210.

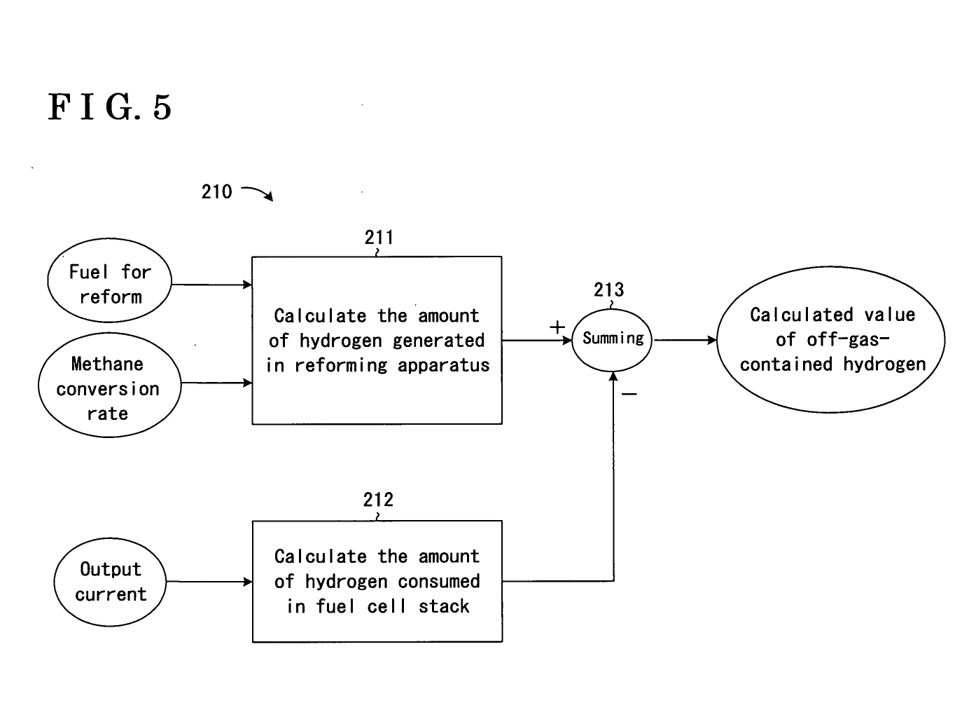

As illustrated in FIG. 5, the portion 210 includes a portion 211 for calculating (assuming) the amount of hydrogen generated in the reforming portion 21 on the basis of the amount of the fuel supplied to the reforming portion 21 and the conversion rate calculated by the portion 110, a portion 212 for calculating the amount of hydrogen consumed by the fuel cell 10 on the basis of the output current of the fuel cell, and a summing portion 213 for calculating the amount of the off-gas-contained hydrogen supplied to the combustion portion 22 on the basis of the amount of generated hydrogen calculated by the portion 211 and the amount of consumed hydrogen calculated by the portion 212.

The portion 211, the portion 212 and the portion 213 calculate the amount of hydrogen generated in the reforming portion 21, the amount of hydrogen consumed by the fuel cell 10, and the amount of off-gas-contained hydrogen supplied to the combustion portion 22 by equations 5 to 7 respectively.
Generated hydrogen [L/min]=Reform hydrogen constant×Fuel supplied for reform [L/min]×Conversion rate [%]/100 [Equation 5]
Consumed hydrogen [L/min]=c1×Output current of fuel cell [A]×The number of cells of fuel cell×mole volume of fluid/Faraday constant [Equation 6]
Supplied off-gas-contained hydrogen [L/min]=Generated hydrogen [L/min]−Consumed hydrogen [L/min] [Equation 7]

In addition, the reform hydrogen constant is set in advance on the basis of fundamental experiment for obtaining the reform hydrogen constant. c1 is a constant for converting the amount of electrons into the amount of hydrogen consumed (30 is utilized in the case of equation 6). The mole number of gas is determined to 24.0 L/mol under the condition of 20° C. and 1 atmospheric pressure. The Faraday constant is 96485 C/mol.

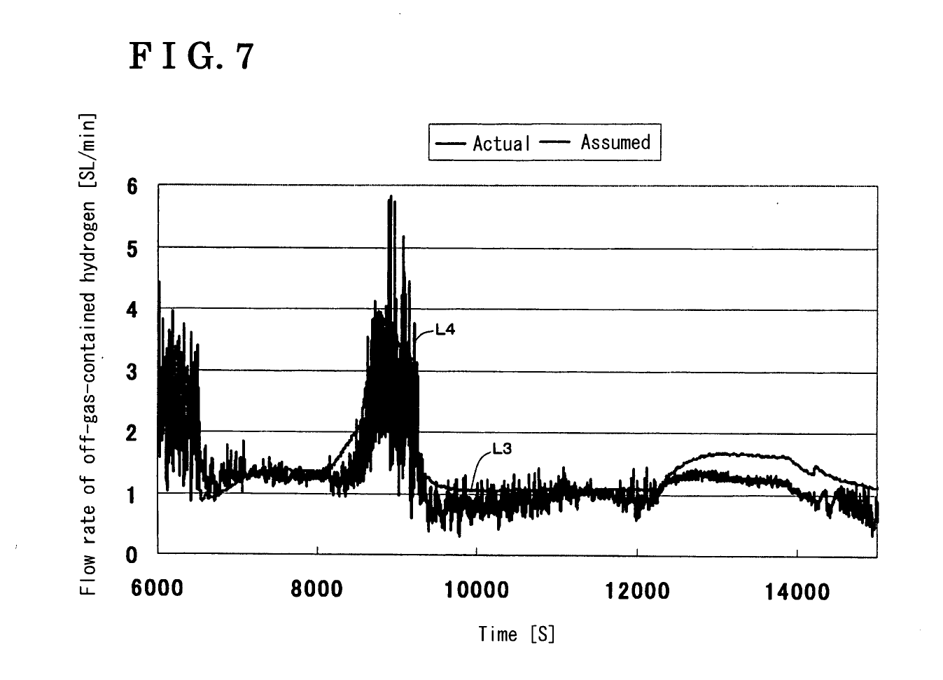

FIG. 7 represents a graph showing the amount of the off-gas-contained hydrogen supplied to the combustion portion 22 (in terms of unit of standard litter per minute) calculated as described above. The assumed amount of the off-gas-contained hydrogen supplied to the combustion portion 22 is drawn by a lighter curve L3. In the same graph, the actual amount of the off-gas-contained hydrogen supplied to the combustion portion 22 actually measured by means of a measuring apparatus is drawn by a darker curve L4. As can be clearly seen from FIG. 7, there is a good correlation between the assumed amount of the off-gas-contained hydrogen supplied to the combustion portion 22 and the actual off-gas-contained hydrogen supplied to the combustion portion 22. Accordingly, the amount of the oxidative gas required for complete combustion of the off-gas-contained hydrogen can be calculated in high precision.

The portion 220 calculates the amount of the oxidative gas required for complete combustion of the off-gas-contained hydrogen supplied to the combustion portion 22 by equation 8 on the basis of the amount of the off-gas-contained hydrogen calculated by the portion 210.
Oxidative gas required for combustion of off-gas-contained hydrogen=2.381×Supplied off-gas-contained hydrogen [L/min] [Equation 8]
In addition, equation 8 can be derived as follows.

Combustion reaction of hydrogen is described as equation 5. For complete combustion of 1 mole of hydrogen, ½ moles of oxygen are required. Assuming that oxygen is contained in air by a ratio of 21%, air required for complete combustion of 1 mole of hydrogen becomes as described in equation 9.
Required air=1/0.21×½[mol]=2.381 [mol] [Equation 9]
In addition, the amount of air derived is a value under the condition that the air-set ratio is set to 1.

The portion 300 calculates the amount of the oxidative gas required for complete combustion of the fuel directly supplied from the fuel source Sf to the combustion portion 22 on the basis of the amount of the fuel directly supplied from the fuel source Sf to the combustion portion 22 and detected by the flowmeter 87.

A portion 310 of calculating the amount of the oxidative gas required for complete combustion of the fuel directly supplied from the fuel source Sf to the combustion portion 22 calculates the amount of the oxidative gas required for complete combustion of the fuel directly supplied from the fuel source Sf to the combustion portion 22 by equation 10 on the basis of the amount of fuel directly supplied from the fuel source Sf to the combustion portion 22 and detected by the flowmeter 87.
Oxidative gas required for combustion of fuel directly supplied=9.524×Directly supplied fuel [L/min] [Equation 10]
In addition, equation 10 described above is derived by a similar way as in the case of equation 3 described above. Here, the fuel is assumed to contain 100% of methane.

In addition, as illustrated in FIG. 3, the control apparatus 30 includes a portion 305 of performing a predetermined filtering process (lowpass filter) on a detection signal transmitted from the flowmeter 87 serving as a means for detecting the amount of the fuel directly supplied to the combustion portion 22. The detection signal processed by the predetermined filtering process is transmitted to the portion 310. Further, the control apparatus 30 includes a portion 135 for performing a filtering process identical with that of the portion 305 on a signal of the amount of the off-gas-contained fuel supplied to the combustion portion 22 transmitted from the portion 130. The signal processed by the filtering process is transmitted to the portion 140. Still further, the control apparatus 30 includes a portion 215 for performing a filtering process identical with that of the portion 305 on a signal of the amount of the off-gas-contained hydrogen supplied to the combustion portion 22 transmitted from the portion 210. The signal processed by the filtering process is transmitted to the portion 220. Accordingly, noises, in particular, large noises included in the signal from the flowmeter 87, can be removed. At the same time, phases of the data transmitted to the portion 310, the portion 140, and the portion 220 can be made identical.

Next, operations of the fuel cell system described above will be explained. When a start switch (not illustrated) is turned on at the time t0, the control apparatus 30 starts start-up operations of the fuel cell system. The control apparatus 30 commands the first reformed gas valve 74 and the off-gas valve 75 to close, and commands the second reformed gas valve 76 to open, so that the CO selective oxidation portion 24 is connected to the burner 22. Then, the control apparatus 30 commands the first fuel valve 42 to open, commands the second fuel valve 45 to close, and commands the fuel pump 48 and the air pump 66 to operate, so that the fuel and air are supplied to the burner 22b. Then, the control apparatus 30 commands the burner 22b to ignite. Accordingly, the fuel is combusted, and the combustion gas heats the reforming catalyst 21a included in the reforming portion 21 and the vaporizer 55.

The control apparatus 30 detects the temperature of the vaporizer 55 by means of the temperature sensor 55a. When the detected temperature becomes to a first predetermined temperature Th1 or higher (at the time t1), the control apparatus 30 commands the water valve 54 to open, and commands the water pump 53 to operate, so that a predetermined amount of flow rate of water (a predetermined amount of water to be supplied) contained in the water tank Sw is supplied to the reforming portion 21 through the vaporizer 55.

The control apparatus 30 starts counting time when the temperature of the vaporizer 55 becomes the first predetermined temperature Th1 or higher (at the time t1). If the counted time becomes a first predetermined time T1 (1 minute or the like) or more, the control apparatus 30 commands the second fuel valve 45 to open, and commands the fuel pump 43 to operate, so that a predetermined flow rate of the fuel (a predetermined amount of the fuel) from the fuel source Sf is supplied to the reforming portion 21. At the same time, the control apparatus 30 commands the air valve 64 to open, and commands the air pump 63 to operate, so that a predetermined flow rate of the air (the predetermined amount of the air) from the air source Sa is supplied to the CO selective oxidation portion 24. Accordingly, the mixed gas of the fuel and vapor is supplied to the reforming portion 21. In the reforming portion 21, the reformed gas is generated through the reform reaction and the carbon monoxide shift reaction described above. Then, the reformed gas extracted from the reforming portion 21 passes through the CO-shift portion 23 and the CO selective oxidation portion 24. While the reformed gas passes through the CO-shift portion 23 and the CO selective oxidation portion 24, the concentration of carbon monoxide is lowered. After that, the reformed gas is extracted from the CO selective oxidation portion 24. Then, the reformed gas is supplied to the burner 22b of the combustion portion 22, and combusted.

While the reformed gas is generated, the control apparatus 30 detects the temperature of the catalyst 24a of the CO selective oxidation portion 24 by means of the temperature sensor 24a1. When the detected temperature becomes a second predetermined temperature Th2 or higher (at the time t4), the control apparatus 30 commands the first reformed gas valve 74 and the off-gas valve 75 to open, and commands the second reformed gas valve 76 to close, so that the CO selective oxidation portion 24 is connected to the inlet of the fuel electrode 11 of the fuel cell 10, and that the outlet of the fuel electrode 11 of the fuel cell 10 is connected to the burner 22b. Accordingly, the start-up operations for warming up the fuel cell system are completed. Next, normal operations of the fuel cell system are started.

The control apparatus 30 starts the normal operations of the fuel cell system (operation mode for generating electricity by the fuel cell 10). At this time, the fuel supplied to the reforming portion 21, the fuel supplied to the combustion portion 22, the air supplied to the combustion portion 22, the air supplied to the CO selective oxidation portion 24, air supplied to the cathode, and water utilized for reform are controlled so as to generate a desired output current (current or power consumed by a load apparatus). The control apparatus 30 calculates the amount of the fuel supplied to the reforming portion 21 by which the desired output current is obtained, and commands the fuel pump 43 to operate so that the calculated amount of the fuel is supplied to the reforming portion 21. Then, the control apparatus 30 calculates the amount of the water supplied to the reforming portion 21 on the basis of the calculated amount of the fuel supplied to the reforming portion 21 and a ratio of steam to carbon (S/C ratio). The control apparatus 30 commands the water pump 53 to operate so that the calculated amount of the water is supplied to the reforming portion 21. When sufficient heat energy required by the combustion portion 22 can not be obtained only by the combustion heat of the off-gas from the anode, or when the fuel cell system is performing the start-up operations, the control apparatus 30 calculates the required amount of the fuel directly supplied from the fuel source Sf to the combustion portion 22, and commands the fuel pump 48 to operate so that the calculated amount of the fuel is supplied to the combustion portion 22. Then, as explained later, the control apparatus 30 calculates the required amount of the air supplied to the combustion portion 22 on the basis of the amount of the fuel supplied to the reforming portion 21. Then, the control apparatus 30 commands the air pump 66 to operate so that the amount of the air is supplied to the combustion portion 22. Further, the control apparatus 30 calculates the amount of the air required to lower the amount of the carbon monoxide to a predetermined amount or lower. Then, the control apparatus 30 commands the air pump 63 to operate so that the calculated amount of the air is supplied to the CO selective oxidation portion 24. Then, the control apparatus 30 calculates the required amount of the air supplied to the cathode sufficient to react with the reformed gas supplied from the reforming apparatus 20. Then, the control apparatus 30 commands the air pump 68 to operate so that the calculated amount of the air is supplied to the cathode. When a stop switch is pushed, the fuel cell system stops the operation.

Further, calculations for the amount of the air supplied to the combustion portion will be explained in detail. In the control apparatus 30, the portion 110 calculates the ratio of the fuel converted into hydrogen, in other words, the conversion rate, on the basis of the amount of the fuel supplied to the reforming portion 21 and the temperature of the reformed gas. The portion 130 calculates the amount of the off-gas-contained fuel supplied to the combustion portion 22 on the basis of the amount of the fuel supplied to the reforming portion 21 and the conversion rate calculated by the portion 110. The portion 140 calculates the amount of the oxidative gas required for complete combustion of the off-gas-contained fuel supplied to the combustion portion 22 on the basis of the amount of the off-gas-contained fuel supplied to the combustion portion 22 calculated by the portion 130. In parallel, the portion 210 calculates the amount of the off-gas-contained hydrogen supplied to the combustion portion 22 on the basis of the output current of the fuel cell, the amount of the fuel supplied to the reforming portion 21, and the conversion rate calculated by the portion 110. The portion 220 calculates the amount of the oxidative gas required for complete combustion of the off-gas-contained hydrogen supplied to the combustion portion 22 on the basis of the amount of the off-gas-contained hydrogen supplied to the combustion portion 22 calculated by the portion 210. Further, in parallel, the portion 310 calculates the amount of the oxidative gas required for complete combustion of the fuel directly supplied from the fuel source Sf to the combustion portion 22 on the basis of the amount of the fuel directly supplied from the fuel source Sf to the combustion portion and detected by the flowmeter 87.

Then, the summing portion 31 sums the calculated amount of the oxidative gas required for complete combustion calculated by each portion for calculating the total amount of the oxidative gas supplied to the combustion portion 22. In the multiplying portion 32, the total amount of the required oxidative gas to be supplied to the combustion portion 22 calculated by the summing portion 31 is multiplied by the air-set ratio. Thus, the amount of air to be supplied is calculated considering properties of the reforming apparatus 21. Then, the portion 33 for controlling the air pump 66 serving as a means for controlling the oxidative gas-supplying means controls the air pump 66 serving as an oxidative gas-supplying means so that the calculated amount of the oxidative gas is supplied to the combustion portion 22.

As can be grasped from above descriptions, in the embodiment, the portion 100 calculates the amount of the oxidative gas required for complete combustion of the off-gas-contained fuel supplied to the combustion portion 22. The portion 200 calculates the amount of the oxidative gas required for complete combustion of the off-gas-contained hydrogen supplied to the combustion portion 22. The portion 300 calculates the amount of the oxidative gas required for complete combustion of the fuel directly supplied from the fuel source Sf to the combustion portion 22 on the basis of the amount of the fuel directly supplied from the fuel source Sf to the combustion portion 22. The summing portion 31 sums the amount of the oxidative gas calculated by each portion 100, 200, and 300 for calculating the amount of the oxidative gas to be supplied to the combustion portion 22. The portion 33 controls the air pump 66 so that the amount of the oxidative gas calculated by the summing portion 31 is supplied to the combustion portion 22. Accordingly, because the appropriate amount of the oxidative gas for combustion of the burnable gas supplied to the combustion portion 22 is supplied to the combustion portion 22 considering the off-gas-contained fuel, combustion of higher efficiency can be performed in the combustion portion 22.

Further, the fuel cell system further includes the reformed gas temperature sensor 86 serving as a reformed gas temperature-detecting means for detecting the temperature of the reformed gas extracted from the reforming portion 21, and the portion 100 calculates the oxidative gas required for complete combustion of the off-gas-contained fuel supplied to the combustion portion 22 on the basis of the amount of the fuel supplied to the reforming portion 21 and the temperature of the reformed gas detected by the reformed gas temperature-detecting means. Accordingly, the amount of the oxidative gas required for complete combustion of the off-gas-contained fuel can be easily calculated. Further, the amount of the oxidative gas required for complete combustion of the burnable gas supplied to the combustion portion 22 can be easily calculated.

Further, the portion 100 includes the portion 110 for calculating the ratio of the fuel converted into hydrogen, in other words, the conversion rate, on the basis of the amount of the fuel supplied to the reforming portion 21 and the temperature of the reformed gas, the portion 130 for calculating the amount of the off-gas-contained fuel supplied to the combustion portion 22 on the basis of the amount of the fuel supplied to the reforming portion 21 and the conversion rate calculated by the portion 110, and the portion 140 for calculating the amount of the oxidative gas required for complete combustion of the off-gas-contained fuel supplied to the combustion portion 22 on the basis of the amount of the supplied off-gas-contained fuel calculated by the portion 130. Accordingly, the amount of the oxidative gas required for complete combustion of the off-gas-contained fuel can be firmly and accurately calculated.

Further, the fuel cell system further includes the inverter 88 serving as the output current-detecting means for detecting the output current of the fuel cell 10 and the temperature sensor 86 serving as the reformed gas temperature-detecting means for detecting the temperature of the reformed gas extracted from the reforming portion 21, and the portion 200 calculates the amount of the oxidative gas required for complete combustion of the off-gas-contained hydrogen supplied to the combustion portion 22 on the basis of the amount of the fuel supplied to the reforming portion 21, the output current of the fuel cell 10 detected by the output current-detecting means, and the temperature of the reformed gas detected by the reformed gas temperature-detecting means. Accordingly, the amount of the oxidative gas required for complete combustion of the off-gas-contained hydrogen can be easily calculated. Further, the amount of the oxidative gas required for complete combustion of the burnable gas supplied to the combustion portion 22 can be easily calculated.

Further, the portion 200 includes the portion 110 for calculating the ratio of the fuel converted into hydrogen, in other words, the conversion rate, on the basis of the amount of the fuel supplied to the reforming portion 21 and the temperature of the reformed gas, the portion 210 for calculating the amount of the off-gas-contained hydrogen supplied to the combustion portion 22 on the basis of the output current of the fuel cell 10, the amount of the fuel supplied to the reforming portion 21, and the conversion rate calculated by the portion 110, and the portion 220 for calculating the amount of the oxidative gas required for complete combustion of the off-gas-contained hydrogen supplied to the combustion portion 22 on the basis of the amount of the off-gas-contained hydrogen calculated by the portion 210. Accordingly, the amount of the oxidative gas required for complete combustion of the off-gas-contained hydrogen can be firmly and accurately calculated.

Further, the portion 110 is configured from the neural network, and the conversion rate is calculated on the basis of learning through the neural network. Accordingly, the conversion rate of high precision can be obtained corresponding to operation conditions of the fuel cell system.

Further, the portion 310 calculates the amount of the oxidative gas required for complete combustion of the fuel directly supplied to the combustion portion 22 on the basis of the signal of amount of the fuel transmitted from the flowmeter 87 and processed by the filtering process. Accordingly, noises included in the detection signal transmitted from the flowmeter 87 can be removed. Therefore, the amount of the oxidative gas required for complete combustion of the fuel supplied to the combustion portion 22 can be calculated in high precision.

As described above, noises included in the detection signal transmitted from the flowmeter 87 can be removed by the filtering process. However, a phase of the detection signal is delayed at the same time. Accordingly, if the amount of the oxidative gas required for complete combustion of the fuel supplied directly from the fuel source Sf to the combustion portion 22 calculated on the basis of the detection signal obtained from the flowmeter 87 as described above is summed with the amount of the oxidative gas required for complete combustion of the off-gas-contained fuel calculated by the portion 100 on the basis of a signal not processed by the filtering process, and the amount of the oxidative gas required for complete combustion of the off-gas-contained hydrogen calculated by the portion 200 on the basis of a signal not processed by the filtering process, there is a danger that the total required amount of the oxidative gas to be supplied to the combustion portion 22 cannot be calculated accurately because the phase of the signal indicating the amount of each oxidative gas supplied to the combustion portion 22 is not identical with others. For preventing this, in the embodiment described above, the fuel cell system further includes the portion 135 for performing the identical filtering process on the signal of the amount of the off-gas-contained fuel supplied to the combustion portion 22 transmitted from the portion 130, and the portion 215 for performing the identical filtering process on the signal of the amount of the off-gas-hydrogen supplied to the combustion portion transmitted from the portion 210. The signal processed by each portion 135 and 215 is transmitted to the portion 140 and 220. Accordingly, because each phase of the amount of the oxidative gas supplied to the combustion portion 22 becomes identical with others, the total required amount of the oxidative gas to be supplied to the combustion portion 22 can be calculated on the basis of each required amount of the oxidative gas to be supplied to the combustion portion 22 having identical phase with others. Thus, the total required amount of the oxidative gas to be supplied to the combustion portion 22 can be calculated in high precision.

In addition, in the embodiment described above, values detected by the flowmeter 87 and the flowmeter 85 are employed as the amount of the fuel supplied to the combustion portion 22 and the fuel supplied to the reforming portion 21. Alternatively, values calculated on the basis of rotational frequencies and a discharge pressure (the level of discharge) of the fuel pump 48 and the fuel pump 43, in other words, controllable values of each pump, can be employed.

In addition, in the embodiment described above, the air pumps 63, 66, 68 are employed as an oxidative gas-supplying means for supplying the oxidative gas from the air source Sa serving as the oxidative gas source. Alternatively, blowers can be employed.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A fuel cell system, comprising:
a reforming portion including a reforming catalyst filled inside the reforming portion for reforming a fuel supplied to the reforming portion into a reformed gas to be introduced to a fuel cell containing hydrogen;
a combustion portion for complete combustion of an off-gas-contained fuel supplied from the fuel cell, an off-gas-contained hydrogen also supplied from the fuel cell, and the fuel supplied directly from a fuel source as a required basis with an oxidative gas supplied by an oxidative gas-supplying means for supplying the oxidative gas to the combustion portion for heating the reforming portion;
a means for calculating the amount of the oxidative gas required for complete combustion of the off-gas-contained fuel supplied to the combustion portion;
a means for calculating the amount of the oxidative gas required for complete combustion of the off-gas-contained hydrogen supplied to the combustion portion;
a means for calculating the amount of the oxidative gas required for complete combustion of the fuel supplied directly from the fuel source to the combustion portion on the basis of the amount of the fuel supplied directly from the fuel source to the combustion portion;
a summing means for calculating the total amount of the required oxidative gas by summing the amount of the required oxidative gas calculated by each means for calculating described above; and
a means for controlling the oxidative gas-supplying means for supplying the oxidative gas to the combustion portion according to the amount of the required oxidative gas calculated by the summing means.

2. The fuel cell system according to claim 1, further comprising:
a reformed gas temperature-detecting means for detecting a temperature of the reformed gas extracted from the reforming portion, wherein
the means for calculating the amount of the oxidative gas required for complete combustion of the off-gas-contained fuel supplied to the combustion portion calculates the amount of the oxidative gas required for complete combustion of the off-gas-contained fuel supplied to the combustion portion on the basis of the amount of the fuel supplied to the reforming portion and the temperature of the reformed gas detected by the reformed gas temperature-detecting means.

3. The fuel cell system according to claim 2, wherein
the means for calculating the amount of the oxidative gas required for complete combustion of the off-gas-contained fuel includes:
a means for calculating a conversion rate of the fuel supplied to the reforming portion converted into hydrogen on the basis of the amount of the fuel supplied to the reforming portion and the temperature of the reformed gas;
a means for calculating the off-gas-contained fuel supplied to the combustion portion on the basis of the amount of the fuel supplied to the reforming portion and the conversion rate calculated by the means for calculating the conversion rate; and
a means for calculating the amount of the oxidative gas required for complete combustion of the off-gas-contained fuel supplied to the combustion portion on the basis of the amount of the off-gas-contained fuel supplied to the combustion portion calculated by the means for calculating the off-gas-contained fuel supplied to the combustion portion.

4. The fuel cell system according to claim 1, further comprising:
an output current-detecting means for detecting an output current of the fuel cell; and
a reformed gas temperature-detecting means for detecting a temperature of the reformed gas extracted from the reforming portion, wherein
the means for calculating the amount of the oxidative gas for complete combustion of the off-gas-contained hydrogen supplied to the combustion portion calculates the amount of the oxidative gas for complete combustion of the off-gas-contained hydrogen supplied to the combustion portion on the basis of the amount of the fuel supplied to the reforming portion, the output current of the fuel cell detected by the output current-detecting means, and the temperature of the reformed gas detected by the reformed gas temperature-detecting means.

5. The fuel cell system according to claim 4, wherein
the means for calculating the amount of the oxidative gas required for complete combustion of the off-gas-contained hydrogen includes:
a means for calculating a conversion rate of the fuel supplied to the reforming portion into hydrogen on the basis of the amount of the fuel supplied to the reforming portion and the temperature of the reformed gas;
a means for calculating the amount of the off-gas-contained hydrogen supplied to the combustion portion on the basis of the output current of the fuel cell, the amount of the fuel supplied to the reforming portion, and the conversion rate calculated by the means for calculating the conversion rate; and
a means for calculating the amount of the oxidative gas required for complete combustion of the off-gas-contained hydrogen supplied to the combustion portion on the basis of the amount of the off-gas-contained hydrogen supplied to the combustion portion calculated by the means for calculating the amount of the off-gas-contained hydrogen supplied to the combustion portion.

6. The fuel cell system according to claim 3, wherein
the means for calculating the conversion rate is configured from a neural network.

7. The fuel cell system according to claim 5, wherein
the means for calculating the conversion rate is configured from a neural network.

8. The fuel cell system according to claim 1, further comprising:
a means for detecting the amount of the fuel supplied directly from the fuel source to the combustion portion; and
a means for performing a filtering process on a detection signal transmitted from the means for detecting the amount of the fuel supplied directly from the fuel source to the combustion portion, wherein
the means for calculating the amount of the oxidative gas required for complete combustion of the fuel supplied directly from the fuel source to the combustion portion calculates the amount of the oxidative gas required for complete combustion of the fuel supplied directly from the fuel source to the combustion portion on the basis of the detection signal processed by the means for performing the filtering process on the detection signal of the amount of the fuel supplied directly from the fuel source to the combustion portion.

9. The fuel cell system according to claim 2, further comprising:
a means for detecting the amount of the fuel supplied directly from the fuel source to the combustion portion; and
a means for performing a filtering process on a detection signal transmitted from the means for detecting the amount of the fuel supplied directly from the fuel source to the combustion portion, wherein
the means for calculating the amount of the oxidative gas required for complete combustion of the fuel supplied directly from the fuel source to the combustion portion calculates the amount of the oxidative gas required for complete combustion of the fuel supplied directly from the fuel source to the combustion portion on the basis of the detection signal processed by the means for performing the filtering process on the detection signal of the amount of the fuel supplied directly from the fuel source to the combustion portion.

10. The fuel cell system according to claim 3, further comprising:
a means for detecting the amount of the fuel supplied directly from the fuel source to the combustion portion; and
a means for performing a filtering process on a detection signal transmitted from the means for detecting the amount of the fuel supplied directly from the fuel source to the combustion portion, wherein
the means for calculating the amount of the oxidative gas required for complete combustion of the fuel supplied directly from the fuel source to the combustion portion calculates the amount of the oxidative gas required for complete combustion of the fuel supplied directly from the fuel source to the combustion portion on the basis of the detection signal processed by the means for performing the filtering process on the detection signal of the amount of the fuel supplied directly from the fuel source to the combustion portion.

11. The fuel cell system according to claim 4, further comprising:
a means for detecting the amount of the fuel supplied directly from the fuel source to the combustion portion; and
a means for performing a filtering process on a detection signal transmitted from the means for detecting the amount of the fuel supplied directly from the fuel source to the combustion portion, wherein
the means for calculating the amount of the oxidative gas required for complete combustion of the fuel supplied directly from the fuel source to the combustion portion calculates the amount of the oxidative gas required for complete combustion of the fuel supplied directly from the fuel source to the combustion portion on the basis of the detection signal processed by the means for performing the filtering process on the detection signal of the amount of the fuel supplied directly from the fuel source to the combustion portion.

12. The fuel cell system according to claim 5, further comprising:
a means for detecting the amount of the fuel supplied directly from the fuel source to the combustion portion; and
a means for performing a filtering process on a detection signal transmitted from the means for detecting the amount of the fuel supplied directly from the fuel source to the combustion portion, wherein
the means for calculating the amount of the oxidative gas required for complete combustion of the fuel supplied directly from the fuel source to the combustion portion calculates the amount of the oxidative gas required for complete combustion of the fuel supplied directly from the fuel source to the combustion portion on the basis of the detection signal processed by the means for performing the filtering process on the detection signal of the amount of the fuel supplied directly from the fuel source to the combustion portion.

13. The fuel cell system according to claim 6, further comprising:
a means for detecting the amount of the fuel supplied directly from the fuel source to the combustion portion; and
a means for performing a filtering process on a detection signal transmitted from the means for detecting the amount of the fuel supplied directly from the fuel source to the combustion portion, wherein
the means for calculating the amount of the oxidative gas required for complete combustion of the fuel supplied directly from the fuel source to the combustion portion calculates the amount of the oxidative gas required for complete combustion of the fuel supplied directly from the fuel source to the combustion portion on the basis of the detection signal processed by the means for performing the filtering process on the detection signal of the amount of the fuel supplied directly from the fuel source to the combustion portion.

14. The fuel cell system according to claim 7, further comprising:
a means for detecting the amount of the fuel supplied directly from the fuel source to the combustion portion; and
a means for performing a filtering process on a detection signal transmitted from the means for detecting the amount of the fuel supplied directly from the fuel source to the combustion portion, wherein
the means for calculating the amount of the oxidative gas required for complete combustion of the fuel supplied directly from the fuel source to the combustion portion calculates the amount of the oxidative gas required for complete combustion of the fuel supplied directly from the fuel source to the combustion portion on the basis of the detection signal processed by the means for performing the filtering process on the detection signal of the amount of the fuel supplied directly from the fuel source to the combustion portion.

15. The fuel cell system according to claim 3, further comprising;
an output current-detecting means for detecting an output current of the fuel cell, wherein
the means for calculating the amount of the oxidative gas required for complete combustion of the off-gas-contained hydrogen supplied to the combustion portion calculates the amount of the oxidative gas required for complete combustion of the off-gas-contained hydrogen supplied to the combustion portion on the basis of the amount of the fuel supplied to the reforming portion, the output current detected by the output current-detecting means, and the temperature of the reformed gas detected by the reformed gas temperature-detecting means.

16. The fuel cell system according to claim 15, wherein
the means for calculating the amount of the oxidative gas required for complete combustion of the off-gas-contained hydrogen supplied to the combustion portion includes:
a means for calculating the amount of the off-gas-contained hydrogen supplied to the combustion portion on the basis of the output current of the fuel cell, the amount of the fuel supplied to the reforming portion, and the conversion rate calculated by the means for calculating the conversion rate; and
a means for calculating the amount of the oxidative gas required for complete combustion of the off-gas-contained hydrogen supplied to the combustion portion on the basis of the amount of the off-gas-contained hydrogen supplied to the combustion portion calculated by the means for calculating the amount of the off-gas-contained hydrogen supplied to the combustion portion.

17. The fuel cell system according to claim 16, further comprising:
a means for detecting the amount of the fuel supplied to the combustion portion; and
a means for performing a filtering process on a detection signal transmitted from the means for detecting the amount of the fuel supplied directly from the fuel source to the combustion portion, wherein
the means for calculating the amount of the oxidative gas required for complete combustion of the fuel supplied directly from the fuel source to the combustion portion calculates the amount of the oxidative gas required for complete combustion of the fuel supplied directly from the fuel source to the combustion portion on the basis of the detection signal processed by the means for performing the filtering process on the detection signal of the amount of the fuel supplied directly from the fuel source to the combustion portion.

18. The fuel cell system according to claim 17, further comprising:
a means for performing a filtering process on a signal of the amount of the off-gas-contained fuel transmitted from the means for calculating the amount of the off-gas-contained fuel supplied to the combustion portion, the filtering process identical with that performed by the means for performing the filtering process on the detection signal transmitted from the means for detecting the amount of the fuel directly from the fuel source to the combustion portion; and
a means for performing a filtering process on a signal of the amount of the off-gas-contained hydrogen transmitted from the means for calculating the amount of the off-gas-contained hydrogen supplied to the combustion portion, the filtering process identical with that performed by the means for performing the filtering process on the detection signal transmitted from the means for detecting the amount of the fuel directly from the fuel source to the combustion portion, wherein
the means for calculating the amount of the oxidative gas required for complete combustion of the off-gas-contained fuel supplied to the combustion portion on the basis of the amount of the off-gas-contained fuel supplied to the combustion portion calculates the amount of the oxidative gas required for complete combustion of the off-gas-contained fuel supplied to the combustion portion on the basis of the signal processed by the means for performing the filtering process on the signal of the amount of the off-gas-contained fuel supplied to the combustion portion, and the means for calculating the amount of the oxidative gas required for complete combustion of the off-gas-contained hydrogen supplied to the combustion portion on the basis of the amount of the off-gas-contained hydrogen supplied to the combustion portion calculates the amount of the oxidative gas required for complete combustion of the off-gas-contained hydrogen supplied to the combustion portion on the basis of the signal processed by the means for performing the filtering process on the signal processed by the means for performing the filtering process on the signal of the amount of the off-gas-contained hydrogen supplied to the combustion portion.

19. The fuel cell system according to claim 18, wherein
the means for calculating the conversion rate is configured from a neural network.
